(19) United States
(12) Patent Application Publication
(10) Pub. No.: US 2025/0347594 A1
(43) Pub. Date: Nov. 13, 2025

(54) HAND-POWERED DAMPER TESTING

(71) Applicants: Kito Brielmaier, Seattle, WA (US); Kevin Muggli, Mountlake Terrace, WA (US)

(72) Inventors: Kito Brielmaier, Seattle, WA (US); Kevin Muggli, Mountlake Terrace, WA (US)

(21) Appl. No.: 18/660,931

(22) Filed: May 10, 2024

(51) Int. Cl. G01M 17/04; G01D 21/02

(52) U.S. Cl. CPC G01M 17/04; G01D 21/02

(57) ABSTRACT

Systems and methods for damper testing. One embodiment is an apparatus including a first frame member, second frame member, and handle. The first frame member is configured to couple with a first end of a damper. The second frame member is pivotably coupled with the first frame member. The second frame member is configured to couple with a second end of the damper. The handle is coupled to the second frame member. The handle is configured to receive a manual force from a human operator to pivot the second frame member. The first frame member is configured to couple with a wall structure to suspend the first frame member off the ground and in a fixed position as the second frame member pivots to compress or extend the damper for performance testing.

### FIELD

The disclosure relates generally to devices and techniques for testing the performance characteristics of dampers or shock absorbers.

### BACKGROUND

Dampers, also known as shock absorbers, are integral components in vehicles such as automobiles, motorcycles, and bicycles. As the name implies, they function to dampen and absorb shock impulses as the vehicle travels over uneven surfaces, contributing to the overall performance, stability, and comfort of the vehicle. The performance of a damper can be evaluated using a device known as a damper dynamometer, or “damper dyno” for short. A damper dyno typically measures the force versus velocity characteristics of a damper. This is achieved by applying a load to the damper and measuring the resulting displacement and velocity. The data collected can then be used to generate graphs that provide insights into the performance of the shock absorber.

Conventional damper dynos, used by automotive and suspension system manufacturers, are equipped with motors and hydraulic or pneumatic systems which compress and extend the damper with controlled forces that simulate real-word conditions. These damper dynos have a large, stationary frame that is capable of withstanding the high forces and repetitive motion of the machinery. The frame rests on the shop floor and requires a relatively large, dedicated space to install and operate the damper dyno. These damper dynos also require a significant amount of power to operate. While these damper dynos are valuable tools for evaluating the performance characteristics of dampers, the cost and size make them prohibitively expensive and difficult to use for many applications.

### SUMMARY

Systems and methods presented herein provide for assessing damper performance with a damper tester that is manually powered, adjustable, and portable. Adjustable components accommodate different damper types and sizes and allow a human operator to ergonomically provide compression/expansion force to the damper without the use of motors, related heavy machinery, and specialized power equipment (e.g., 240 volt or 3-phase power outlets and related electronics), reducing cost and simplifying operation while still providing accurate damper performance measurements. The damper tester is foldable and transportable for installation at different sites with ease. For example, it may be secured to a shop wall where it does not take up valuable floor space, or mounted on a vehicle structure where it can be used on-site at a track or motorsport event. This enables, for example, small motorsport shops or enthusiasts to test or rebuild dampers in areas where floor space is limited or at remote sites.

One embodiment is an apparatus including a first frame member, second frame member, and handle. The first frame member is configured to couple with a first end of a damper. The second frame member is pivotably coupled with the first frame member. The second frame member is configured to couple with a second end of the damper. The handle is coupled to the second frame member. The handle is configured to receive a manual force from a human operator to pivot the second frame member. The first frame member is configured to couple with a wall structure to suspend the first frame member off the ground and in a fixed position as the second frame member pivots to compress or extend the damper for performance testing.

In a further embodiment, the apparatus includes a displacement sensor configured to measure displacement of the damper as the second frame member pivots relative to the first frame member; a force sensor configured to measure force produced by the damper as the second frame member pivots relative to the first frame member; and a transceiver configured to receive displacement data from the displacement sensor and force data from the force sensor, and to transmit the displacement data and the force data to a computer device to display damping characteristics of the damper.

In a further embodiment, the force sensor comprises a load cell positioned between the damper and the second frame member. In another further embodiment, the displacement sensor comprises an angular potentiometer aligned with a hinge axis of the second frame member. In a further embodiment, the first frame member includes a first attachment structure configured to attach to the first end of the damper, the first attachment structure being adjustable along a length of the first frame member; and the second frame member includes a second attachment structure configured to attach to the second end of the damper, the second attachment structure being adjustable along a length of the second frame member. In yet a further embodiment, the first frame member is a first hollow tubular structure, comprising: a back side including one or more fastener support holes to secure the back side to the wall structure via one or more fasteners; side walls including opposing pairs of holes to support the first attachment structure; and a front side including an opening to access a hollow interior of the first hollow tubular structure, wherein the opening aligns with the one or more fastener support holes of the back side to access the one or more fasteners to attach or detach the back side to or from the wall structure.

In a further embodiment, the second frame member is a second hollow tubular structure, comprising: a back side including a series of holes spaced lengthwise to support the second attachment structure; and a front side including an opening to access a hollow interior of the second hollow tubular structure. In yet a further embodiment, the handle comprises: a tubular sleeve coupled to the back side of the second frame member; a telescoping arm configured to slide and secure with respect to the tubular sleeve; and a handlebar coupled to the telescoping arm. In another further embodiment, the first frame member and the second frame member are configured to fold about a hinge axis to a closed position in which respective front sides face and contact each other; and in the closed position, the first attachment structure situates at least partially through the opening in the front side of the second frame member, and the second attachment structure situates at least partially through the opening in the front side of the first frame member.

Another embodiment is a method for testing a damper using a damper testing device. The method includes securing a first frame member of the damper testing device to a wall to suspend the first frame member off the ground and in a fixed position; mounting the damper between the first frame member and a second frame member that is pivotably attached to the first frame member; and applying a manual force to the second frame member to compress or extend the damper as the second frame member pivots to test a performance of the damper.

In a further embodiment, the method includes receiving, from sensors coupled to the damper testing device, displacement data and force data measured during the test of the damper; generating damper performance data based on the displacement data and the force data; and displaying the damper performance data. In a further embodiment, the method includes receiving input indicating the type of the damper to be installed with the damper testing device; and generating, based on the type of damper, a first notification for a user indicating first instructions for attaching the damper to the damper testing device. In yet a further embodiment, the method includes receiving confirmation that the damper is attached to the damper testing device according to the first instructions; generating, in response to the confirmation, a second notification for the user indicating second instructions for calibration of one or more sensors of the damper testing device; generating, in response to confirming the calibration of the one or more sensors, a third notification for the user indicating third instructions for hand-operating the damper testing device to test the damper; and generating the damper performance data based on the type of damper and the displacement data and the force data.

Yet another embodiment is a damper dyno system. The damper dyno system includes a damper dyno, comprising: a first frame member configured to couple with a first end of a damper; a second frame member pivotably coupled with the first frame member, the second frame member configured to couple with a second end of the damper; a handle coupled to the second frame member, the handle configured to receive a manual force from a human operator to pivot the second frame member; and sensors configured to measure displacement and force of the damper as the second frame member pivots relative to the first frame member; wherein the first frame member is configured to couple with a wall structure to suspend the first frame member off the ground and in a fixed position as the second frame member pivots to compress or extend the damper for performance testing. The damper dyno system also includes a damper dyno computer system, comprising: an interface configured to receive displacement data and force data from the sensors; a processor configured to generate damping characteristics of the damper based on the displacement data and the force data; and a display configured to display the damping characteristics of the damper. In a further embodiment, the damper dyno computer system further comprises data storage configured to store dyno configuration data for different types of dampers, wherein the processor is configured to generate instructions for operating the damper dyno based on the dyno configuration data.

### DESCRIPTION OF THE DRAWINGS

Some embodiments of the present invention are now described, by way of example only, and with reference to the accompanying drawings. The same reference number represents the same element or the same type of element on all drawings.

FIG. 1A is a perspective view of a damper tester in an illustrative embodiment.

FIG. 1B is a perspective view of a damper tester in another illustrative embodiment.

FIG. 2 is a perspective view of a first frame member in an illustrative embodiment.

FIG. 3A is a perspective view of a first support structure in an illustrative embodiment.

FIG. 3B is a perspective view of a second support structure in an illustrative embodiment.

FIG. 3C is a perspective view of a third support structure in an illustrative embodiment.

FIG. 4 is another perspective view of a damper tester in an illustrative embodiment.

FIG. 5 is a block diagram of a dyno processing system in an illustrative embodiment.

FIG. 6 is a flowchart illustrating a method for testing a damper in an illustrative embodiment.

FIG. 7 is a flowchart illustrating a method for testing a damper in another illustrative embodiment.

FIG. 8 illustrates a processing system operable to execute a computer readable medium embodying programmed instructions to perform desired functions in an illustrative embodiment.

### DESCRIPTION

The figures and the following description illustrate specific illustrative embodiments of the disclosure. It will thus be appreciated that those skilled in the art will be able to devise various arrangements that, although not explicitly described or shown herein, embody the principles of the disclosure and are included within the scope of the disclosure. Furthermore, any examples described herein are intended to aid in understanding the principles of the disclosure, and are to be construed as being without limitation to such specifically recited examples and conditions. As a result, the disclosure is not limited to the specific embodiments or examples described below, but by the claims and their equivalents.

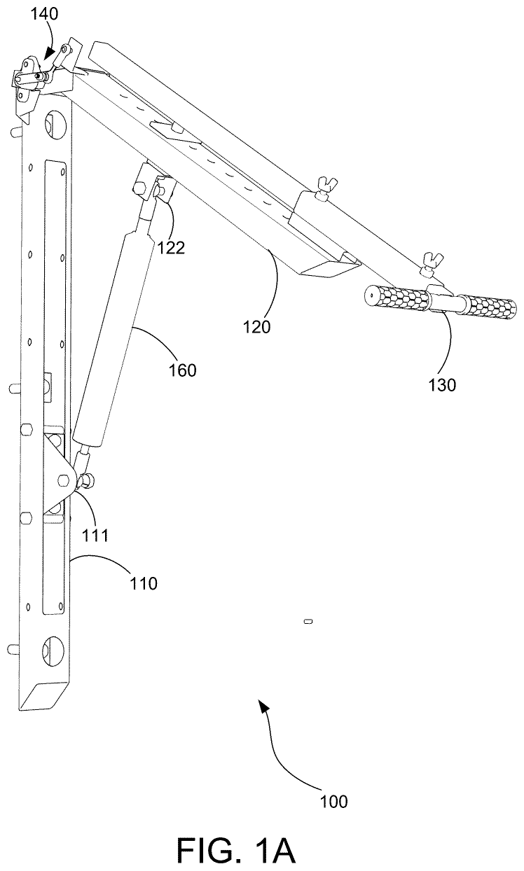

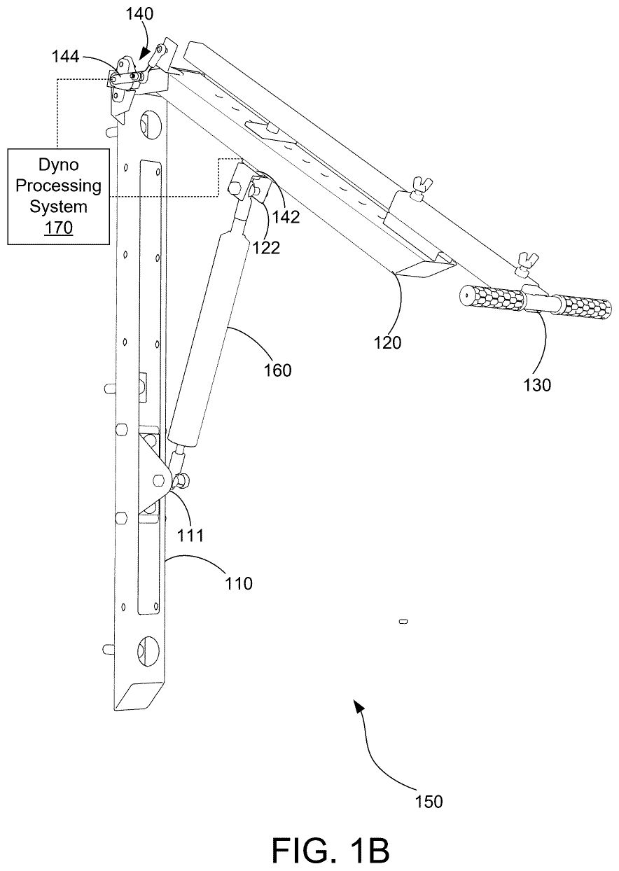

FIG. 1A is a perspective view of a damper tester 100 in an illustrative embodiment. In general, damper tester 100 is used for testing the performance of a damper 160, also known as a shock absorber. Damper 160 may comprise a hydraulic or pneumatic damper for use with a vehicle (e.g., car, motorcycle, snowmobile, all-terrain vehicles, etc.), bicycle, or various industrial applications. For use with a vehicle, for example, damper 160 functions to smooth out or dampen the motion of the vehicle over uneven surfaces. To test the performance of damper 160, it may be removed from the vehicle and mounted to damper tester 100.

Damper tester 100 includes a first frame member 110, a second frame member 120, and a hinge 140. First frame member 110 is configured to attach to a rigid structure, such as a wall of a building or automotive shop, to provide a stable base for damper tester 100 during testing. Second frame member 120 is coupled to first frame member 110 via hinge 140. Second frame member 120 may also include or couple with a handle 130 to receive manual force of a human operator, and translate the force into pivoting movement of second frame member 120.

Damper 160 is mounted between first frame member 110 and second frame member 120 for testing. In particular, first frame member 110 includes a first attachment structure 111 configured to attach to one end of damper 160, and second frame member 120 includes a second attachment structure 122 configured to attach to the other end of damper 160. First attachment structure 111 and/or second attachment structure 122 may be adjustable along their respective axis to adjust the mounting position of damper 160. With damper 160 attached and disposed between first frame member 110 and second frame member 120, handle 130 may be manually controlled to pivot second frame member 120 about hinge 140, applying force to damper 160 and causing it to compress or extend.

In one embodiment, damper tester 100 is operated without the use of electronic devices such as sensors, and damper 160 is tested by manually controlling the speed and force of second frame member 120 and observing the response of damper 160. Handle 130 coupled to second frame member 120 may provide direct tactile feedback to the operator. As damper 160 resists movement, the operator can feel the resistance through handle 130, giving an immediate sense of the stiffness and damping characteristics of damper 160. For instance, the operator may feel damper 160 is damaged or not performing correctly if its resistance is significantly decreased from its normal operating state.

FIG. 1B is a perspective view of a damper tester 150 in another illustrative embodiment. As shown in FIG. 1B, damper tester 150 in some embodiments may include, in addition to the mechanical components previously described with respect to FIG. 1A, one or more sensors for measuring performance of damper 160. In particular, damper tester 150 may include a force sensor 142 and displacement sensor 144. In such embodiments, damper tester 150 may also be referred to as a damper dynamometer or damper dyno.

During testing, force sensor 142 measures a force of damper 160 as it undergoes compression and/or rebound. Simultaneously, displacement sensor 144 measures the movement (e.g., distance and/or velocity) of damper 160 as it undergoes compression and/or rebound. That is, as second frame member 120 moves due to an external manual force applied to handle 130, force sensor 142 and displacement sensor 144 measure the response of damper 160 to these forces, such as its damping rate and resistance to movement. Force sensor 142 and displacement sensor 144 provide measurements to a dyno processing system 170, which may or may not be a component of damper tester 150.

Dyno processing system 170 may process and align the measurement data and generate force-displacement graphs and/or force-velocity graphs. Such graphs serve as a valuable tool for evaluating the performance and behavior of damper 160 under different operating conditions. For example, a force-velocity graph may show how the damping force varies depending on direction of movement (compression or rebound). That is, the slope and shape of the curve may differ between compression damping (when damper 160 is being compressed) and rebound damping (when damper 160 is being extended), providing insight into hysteresis and the energy dissipation and efficiency of damper 160. Various graph characteristics may inform the human operator how to fine-tune damper 160 for performance, efficiency, and durability for specific applications.

Damper testers 100/150 provide several technical advantages over conventional damper testing devices and damper dynos. As compared to damper dynos which can only be placed on a horizontal surface such as the ground, a floor, or a table, damper testers 100/150, having features that enable easily attaching and detaching to walls or structures off the floor, provides several benefits in terms of enhanced stability, space optimization, and portability. Moreover, the structure of damper testers 100/150 allows for human-powered operation, offering enhanced control and sensitivity during testing. It also features a foldable structure for ease of storage and transportation, as well as adjustable mounting points for compatibility with a wide range of damper models and damper mounting angles. The handle adjustability, alone or in combination with the adjustable mounting points, also provide customization options for the user's desired range of motion, leverage, ergonomics, and test conditions. Still further, damper testers 100/150 are suitable to be equipped with various sensors to measure forces, displacements, and velocities, providing comprehensive data on the damper's behavior under test conditions, enabling precise analysis of the damper's performance, including its efficiency, durability, and suitability for specific applications at remote sites. Further details of these features as well as additional features and advantages are discussed below.

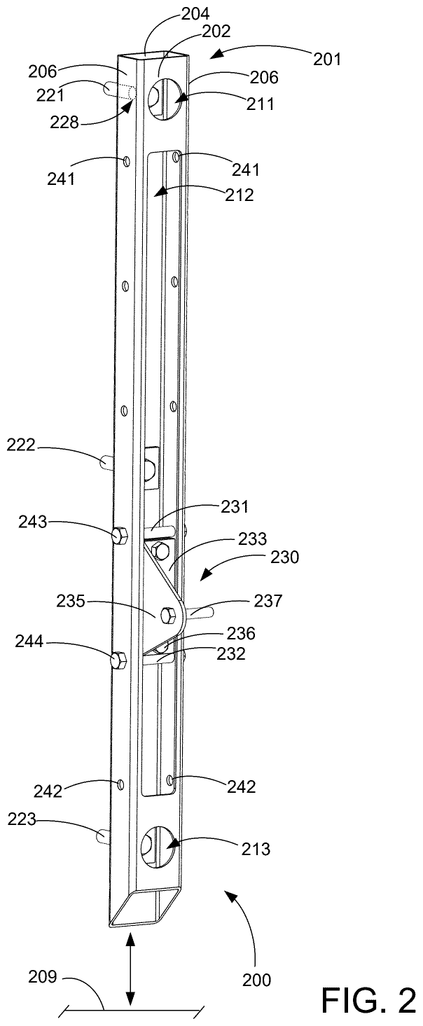

FIG. 2 is a perspective view of a first frame member 200 in an illustrative embodiment. First frame member 200 is an example of first frame member 110 shown and described with respect to FIGS. 1A-B. First frame member 200 includes a hollow tubular body 201 that is square or rectangular in shape with a front side 202, back side 204, and sides 206. Sides 202-206 may comprise flat surfaces, enabling secure attachment of back side 204 to a wall or similar structure, as well as secure, adjustable attachment with a damper, as described in further detail below. When attached to a wall or similar structure, first frame member 200 may provide an elongated vertical structure suspended from ground 209, enabling space savings and a secure structure that is fixed for damper testing accuracy and safety. First frame member 200 may comprise a material of suitable strength for withstanding the manual forces applied for damper testing, such as steel, aluminum, or a composite material.

Front side 202 may include one or more openings 211-213, such as an upper opening 211, middle opening 212, and lower opening 213. Openings 211-213 provide access to the hollow area of hollow tubular body 201 to facilitate mounting of first frame member 110 to another structure. In this example, upper opening 211 provides access to an upper fastener 221, middle opening 212 provides access to a middle fastener 222, and lower opening 213 provides access to a lower fastener 223. Each fastener 221-223 is configured to insert through a corresponding fastener hole 228 (only one shown in FIG. 2 for clarity of illustration) of back side 204 to secure with a wall or similar structure. Fasteners 221-223 advantageously facilitate first frame member 200 being easily switched between an upright position and an upside-down position, depending on user damper testing preference. It may be desirable or more ergonomic, for instance, for a user to operate damper tester 100 upside-down to measure damper rebound (i.e., extending the damper) or prioritize rebound testing over compression testing. This may be easily accomplished by detaching upper fastener 221 and lower fastener 223, loosening middle fastener 222 to allow rotation of first frame member 200 to the desired position, and reattaching fasteners 221-223.

Middle opening 212 may comprise a cutout in the material of front side 202 that is configured to expose the interior of hollow tubular body 201 for attaching and detaching a at various locations up and down a length of first frame member 200. Middle opening 212 may extend lengthwise to expose and provide access to pairs of holes located on sides 206 at different locations along the length of hollow tubular body 201. For instance, middle opening 212 may extend from an upper pair of holes 241 proximate to an upper portion of hollow tubular body 201 to a pair of lower holes 242 proximate to a lower portion of hollow tubular body 201. In some embodiments, first frame member 200 may include a series of pairs of holes (e.g., between five and ten pairs, not all of which are labelled in FIG. 2 for clarity of illustration) on its sides 206 to support incremental vertical adjustment of damper attachment structure 230.

The removed material of middle opening 212 and hollow tubular body 201 contribute to the lightweight design and portability of first frame member 200. Front side 202 may nonetheless include some flat surface material, such as an area above upper pair of holes 241 and below upper opening 211 and an area below lower pair of holes 242 and above lower opening 213, to provide rigidity in the structure of first frame member 200 to support its attachments and withstand testing forces. The cutout created by middle opening 212 may also serve to house one or more features of the second frame member inside first frame member 200 when in a folded or stowed configuration. For example, the attachment structure, force sensor, and/or displacement sensor attached to the second frame member may stow inside the hollow area of first frame member 200 to enhance portability and protection of components during transport.

Each pair of holes along sides 206 are configured to align and attach with features of damper attachment structure 230 such that damper attachment structure 230 is adjustable at different positions up and down the length of first frame member 200. In this example, damper attachment structure 230 includes a base plate 233 with an upper sleeve 231 and a lower sleeve 232. Upper sleeve 231 and lower sleeve 232 are each attachable to a pair of holes (e.g., via respective bolts 243-244) along sides 206 to position damper attachment structure 230 at a desired location on the length of first frame member 200.

A damper mounting plate 235 connects to, and extends forward from, base plate 233. Damper mounting plate 235 may comprise an L-shaped bracket with a base portion attached to base plate 233 via one or more bolts 236, and an arm portion extending forward and including a hole to support a damper connection bolt 237 for attaching to one end of a damper. In one embodiment, damper mounting plate 235 is swappable with one or more other versions having a different attachment structure to accommodate different types of dampers.

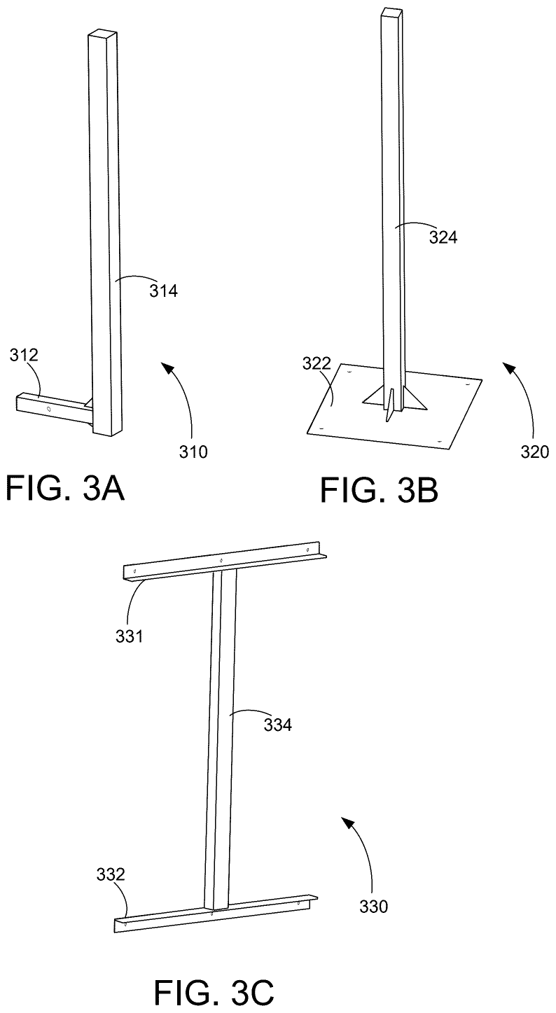

FIGS. 3A-C show example supporting structures for a damper testing device disclosed herein. FIG. 3A is a perspective view of a first support structure 310 in an illustrative embodiment. First support structure 310 includes a base member 312 configured to support and suspend a vertical support member 314. In one embodiment, base member 312 comprises a hitch receiver member (e.g., as shown in FIG. 3A) configured to couple with a hitch receiver of an automobile. Alternatively, base member 312 may comprise a vice base structure configured to vice grip with another structure. Vertical support member 314 may thus provide a stable wall structure for attaching with and securely supporting a first frame member (e.g., first frame member 110/200) of a damper tester. This advantageously enables use of the damper tester at remote locations such as on-site at a track or motorsport event.

FIG. 3B is a perspective view of a second support structure 320 in an illustrative embodiment. Second support structure 320 includes a ground plate 322 that rests on the floor or ground. Ground plate 322 supports a vertical support member 324 to couple with a first frame member (e.g., first frame member 110/200) of a damper tester. Accordingly, a damper tester such as that disclosed herein may retain the option of using the damper tester using the ground or floor as support if desired, enabling use of the damper tester at various locations.

FIG. 3C is a perspective view of a third support structure 330 in an illustrative embodiment. Third support structure 330 includes an upper horizontal support member 331, a lower horizontal support member 332, and a vertical support member 334 coupled between horizontal support members 331-332. In one embodiment, horizontal support members 331-332 comprise rigid members configured to attach with wall, such as wooden studs. In another embodiment, horizontal support members 331-332 comprise straps configured to attach around another object, such as a tree. In any case, horizontal support members 331-332 support vertical support member 334 which in turn provides a stable wall structure for attaching with and securely supporting a first frame member (e.g., first frame member 110/200) of a damper tester, enabling use of the damper tester at various locations.

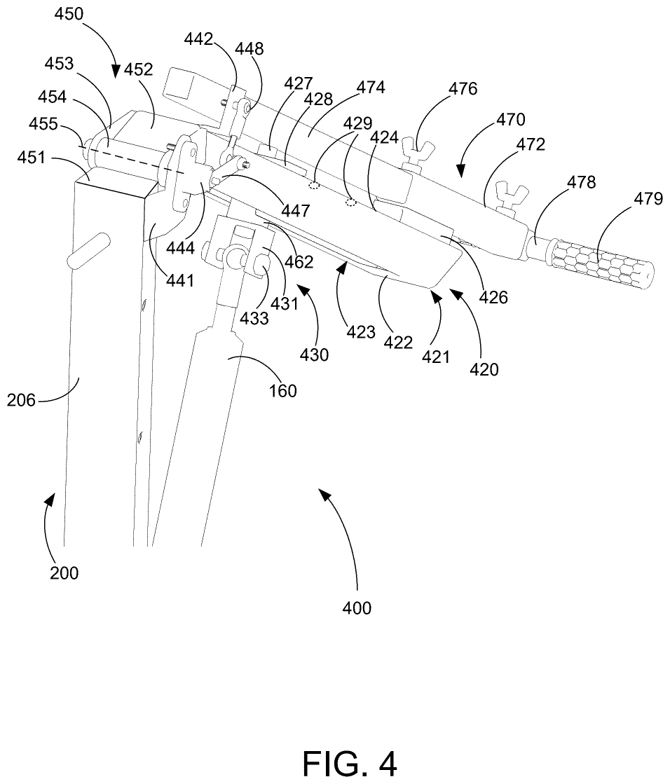

FIG. 4 is another perspective view of a damper tester 400 in an illustrative embodiment. FIG. 4 shows a hinge mechanism 450 which is an example of hinge 140 shown in FIGS. 1A-B. FIG. 4 also shows details of a second frame member 420 which is an example of second frame member 120 shown and described with respect to FIGS. 1A-B.

Hinge mechanism 450 generally comprises a robust pivot structure to facilitate the relative movement between first frame member 200 and second frame member 420 along a controlled axis of rotation. Hinge mechanism 450 may pivotably join the respective upper ends of first frame member 200 and second frame member 420. For instance, hinge mechanism 450 may include or attach with plates 451-452 disposed at respective ends of first frame member 200 and second frame member 420. Plates 451-452 may be joined by a hinge bracket 453 supporting a hinge sleeve 454, and hinge sleeve 454 may house a pin, bearing, and bushing to provide the pivot axis or hinge axis 455. In one embodiment, hinge mechanism 450 is supported on top of the upper end of first frame member 200 and at a position with hinge axis 455 slightly forward from first frame member 200 such that hinge mechanism 450 does not interfere with a wall structure behind.

Second frame member 420 includes a hollow tubular body 421 that is square or rectangular in shape with a front side 422 and back side 424. Sides 422-424 may comprise flat surfaces. Second frame member 420 may extend from first frame member 200 through a range of horizontal angles. Second frame member 420 includes a series of holes 429 (e.g., between five to twelve holes, not all of which are shown or labelled in FIG. 4 for clarity of illustration) spaced lengthwise along back side 424 to support incremental horizontal adjustment of a damper structure 430, and thus position adjustment of damper 160 along the length of second frame member 420. Moreover, when damper 160 is disconnected and removed from damper tester 400, second frame member 420 may fold to a closed position where it is flush, or substantially parallel, with first frame member 200, enhancing portability. Second frame member 420 and hinge mechanism 450 may comprise material of suitable strength for withstanding the manual forces applied for damper testing, such as steel, aluminum, or a composite material.

Damper tester 400 includes a potentiometer 444 positioned to detect the relative movement between frame member 200 and second frame member 420 as damper 160 is compressed or extended. Potentiometer 444 is an example of displacement sensor 144 of FIG. 1B. In this example, potentiometer 444 is an angular potentiometer with its shaft positioned in alignment with hinge axis 455, allowing it to rotate in unison with the movement of second frame member 420. Potentiometer 444 is mounted on a first bracket 441 which is attached at or near a top or upper end portion of first frame member 200. The rotation axis of potentiometer 444 couples to second frame member 420 via one or more pivot links 447-448 and a second bracket 442. Second bracket 442 is attached at or near a top or upper end portion of second frame member 420.

The rotation of potentiometer 444 causes a change in its resistance, which is proportional to the angle through which it has turned. By measuring the change, or rate of change, of this resistance over time, the angular position or velocity of second frame member 420 may be determined. The angular position or velocity may be used to calculate a compression or extension position or velocity of damper 160. In one embodiment, a processor, such as that of dyno processing system 170, receives input from a user indicating an attachment position of damper 160 with respect to first frame member 200 and second frame member 420, and calculates the displacement or velocity of damper 160 based on the position input and sensor data.

Damper tester 400 also includes a load cell 462 positioned between second frame member 420 and damper 160 to detect force produced by damper 160 as it compresses and extends. Load cell 462 is an example of force sensor 142 of FIG. 1B. In this example, load cell 462 extends through an open front face 423 of second frame member 420. Open front face 423 may face or touch the front side (e.g., front side 202 shown in FIG. 2) of first frame member 200 when in a folded configuration and may facilitate folding and transportation of damper tester 400 by providing a housed space for sensors and/or damper attachment structures of first frame member 200 and/or second frame member 420. Load cell 462 may attach with a back side 424 of second frame member 420 via a bolt 427 and washer 428. The other end of load cell 462 may couple with damper attachment structure 430 of second frame member 420. Damper attachment structure 430 may comprise a U-shaped bracket 431 to support a damper connection bolt 433 for attaching to an end of damper 160.

Handle 470 is coupled with back side 424 of second frame member 420. Handle 470 includes a tubular sleeve 472 that is generally directly or indirectly attached with back side 424 of second frame member 420 with its lengthwise axis parallel, or substantially parallel, with the lengthwise axis of second frame member 420. In one embodiment, tubular sleeve 472 is indirectly attached with back side 424 of second frame member 420 via a block structure 426 to provide a space offset between handle 470 and back side 424. Handle 470 also includes a telescoping arm 474 to slide lengthwise within tubular sleeve 472. The space offset provided by block structure 426 may allow telescoping arm 474 to adjust lengthwise without interfering with bolt 427 due to the space offset. Tubular sleeve 472 and telescoping arm 474 may comprise a square or rectangular profile as shown in FIG. 4 or may alternatively comprise a round profile.

One or more clamping fasteners 476, such as wing nuts, may secure or loosen telescoping arm 474 with respect to tubular sleeve 472, enabling length adjustment of handle 470, and positioning of handlebar 478 and grip 479 further from, or closer to, hinge axis 455 for desired leverage position during testing. For example, to increase tactile feedback for manually observing damping characteristics, an operator may adjust handle 470 to a short length, and may also adjust damper attachments to orient damp 160 to a more horizontal position, such that the amount of manual force relative to damper travel is increased, and the amount of tactile feedback through handle 470 is increased. In an alternative example, to test damper 160 at higher forces, the operator may increase handle length and orient damper 160 more vertically to increase leverage such that the amount of manual force relative to damper travel is decreased. An additional technical benefit of handle 470 is that it may be easily adjusted to a desired carrying position, stowed position, or removed for transport.

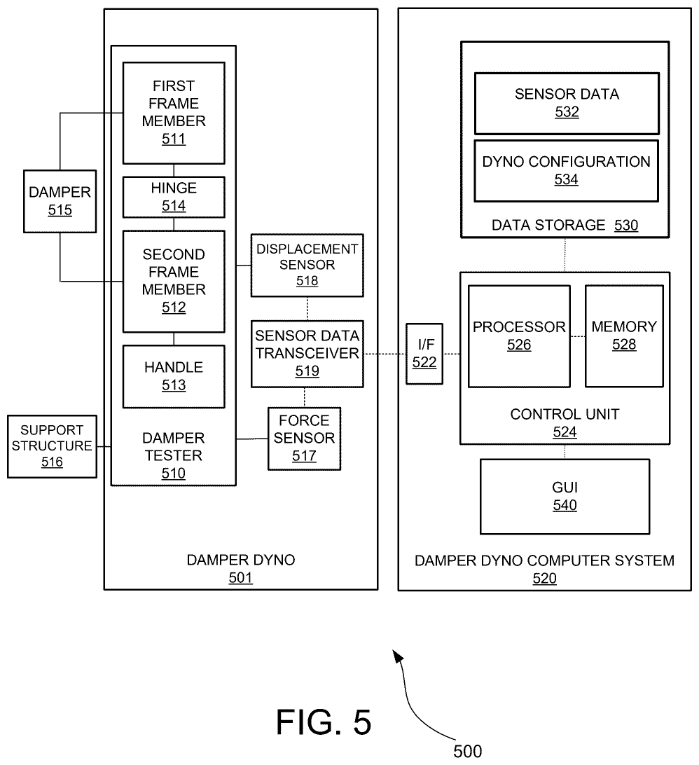

FIG. 5 is a block diagram of a damper dyno system 500 in an illustrative embodiment. Damper dyno system 500 includes a damper dyno 501 and a damper dyno computer system 520. Damper dyno 501 includes a damper tester 510 with a first frame member 511, second frame member 512, handle 513, and hinge 514, similar to damper testers previously discussed. Various types of dampers 515 can be coupled and uncoupled from damper tester 510, and dampers 515 may be attached at various orientations between first frame member 511 and second frame member 512. Damper tester 510 may also be supported by various support structures 516, as previously discussed.

Damper tester 510 may also include, or couple with, a force sensor 517, displacement sensor 518, and/or sensor data transceiver 519. Examples of force sensor 517 include load cells, magnetometers, piezoresistive strain gauges, capacitive force sensors, and fiber optic load sensors. Examples of displacement sensor 518 include angular potentiometers, linear potentiometers, Hall effect sensors, rotary encoders, linear encoders, laser displacement sensors, inductive proximity sensors, piezoelectric accelerometers, Near Field Communication (NFC) sensors, and variable reluctance sensors. Other examples of sensors which may be used with damper tester 510 include temperature sensors, optical motion tracking, video visual tracking, audio tracking, sonar sensors, ultrasonic sensors, and LIDAR sensors. Sensors may attach and position with respect to damper tester 510 and/or damper 515 in various manners depending on sensor type. Each sensor may communicate its measurement data to damper dyno computer system 520 directly or via sensor data transceiver 519.

Damper dyno computer system 500 includes a control unit 524 equipped with a processor 526 and memory 528. Processor 526 executes instructions to control the testing process, while memory 528 stores the instructions and temporary data for real-time processing. Damper dyno computer system 500 also includes data storage 530 configured to collect and store sensor data 532 collected during damper testing. Additionally, data storage 530 may store dyno configuration data 534, which includes settings and parameters specific to each testing scenario. For example, dyno configuration data 534 may associate a type of damper with the attachment points, or holes of first/second frame members, for installing that type of damper with damper tester 510. Dyno configuration data 534 may facilitate quickly and accurately configuring the damper dyno for a variety of tests, optimizing the testing process for different damper types and testing scenarios.

Damper dyno computer system 500 also includes an interface 522 configured to communicate data between the damper dyno and control unit 524. Interface 522 may collect raw data from the sensors operating with the damper dyno, such as force, displacement, and velocity measurements. This data is then relayed to control unit 524, where it is processed and analyzed. As such, interface 522 and control unit 524 may function as a data acquisition system configured to collect and process sensor data for presentation. Control unit 524 may thus include hardware components for analog-to-digital conversion and data conditioning, and interface 522 may communicate the processed data to another computer or display device. Alternatively or additionally, damper dyno computer system 500 may include a graphical user interface (GUI) 540 to display damper measurement data and analysis results, such as force-velocity graphs. GUI 540 may also enable users to input configuration settings, initiate tests, and retrieve stored data from data storage 530.

In some embodiments, one or more components of damper dyno computer system 520 may be included or attached on or near damper tester 510. For example, one or more data transmission and/or processing components may be attached on, or housed within, a frame member of damper tester 510, or mounted nearby on the wall structure. Raw or processed data may be wirelessly transmitted (e.g., via sensor data transceiver 519 and/or interface 522) to a user device, such as a laptop or smartphone, to process and/or visually present the data. As such, components of damper dyno computer system 520 may be distributed across multiple devices or systems, and at least some of the components may be integrated with damper tester 510 in portable fashion. In some embodiments, force sensor 517, displacement sensor 518, sensor data transceiver 519, and/or one or more components of damper dyno computer system 520 may be battery powered.

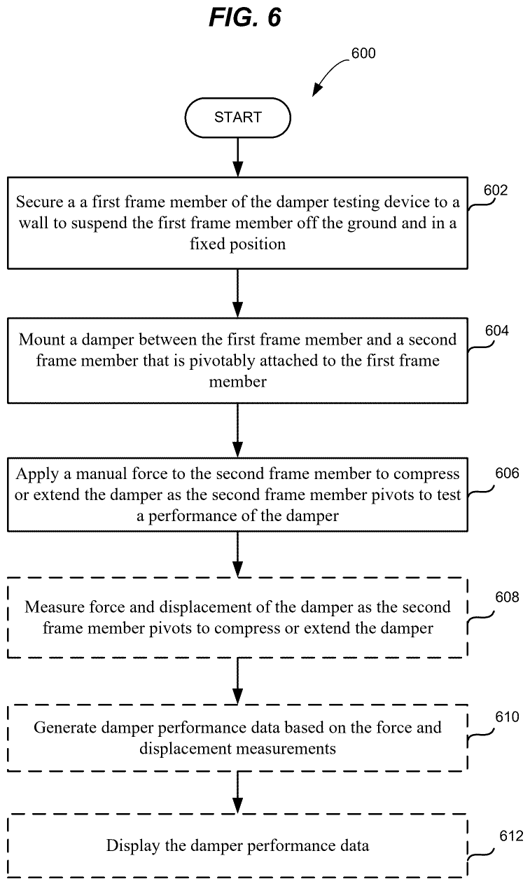

FIG. 6 is a flowchart 600 illustrating a method for testing a damper in an illustrative embodiment. Steps of flowchart 600 may include additional or alternative steps not shown, and may be performed in an alternative order.

In step 602, A first frame member of a damper testing device is secured to a wall to suspend the first frame member off the ground and in a fixed position. In step 604, a damper is mounted between the first frame member and a second frame member that is pivotably attached to the first frame member. In step 606, a manual force is applied to the second frame member to compress or extend the damper as the second frame member pivots to test a performance of the damper.

In optional step 608, force and displacement of the damper is measured as the second frame member pivots to compress or extend the damper. In optional step 610, damper performance data is generated based on the force and displacement measurements. In optional step 612, damper performance data is displayed.

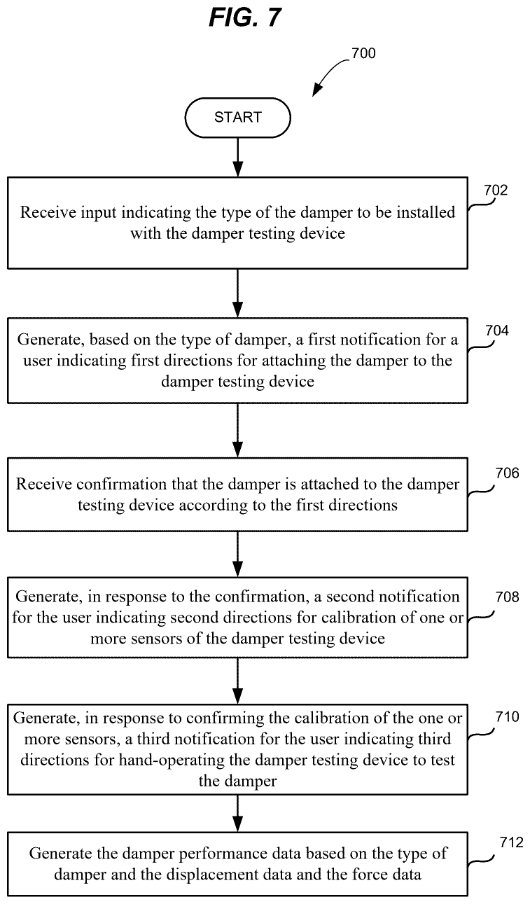

FIG. 7 is a flowchart 700 illustrating a method for testing a damper in another illustrative embodiment. Steps of flowchart 700 may include additional or alternative steps not shown, may be performed in an alternative order, and may be performed in conjunction with one or more steps of flowchart 600.

In step 702, a processor or damper dyno computer system, receives input indicating the type of the damper to be installed with the damper testing device. In step 704, the processor generates, based on the type of damper, a first notification for a user indicating first directions for attaching the damper to the damper testing device. In step 706, the processor receives confirmation that the damper is attached to the damper testing device according to the first directions.

In step 708, the processor generates, in response to the confirmation, a second notification for the user indicating second directions for calibration of one or more sensors of the damper testing device. In step 710, the processor generates, in response to confirming the calibration of the one or more sensors, a third notification for the user indicating third directions for hand-operating the damper testing device to test the damper. In step 712, the processor generates the damper performance data based on the type of damper and the displacement data and the force data.

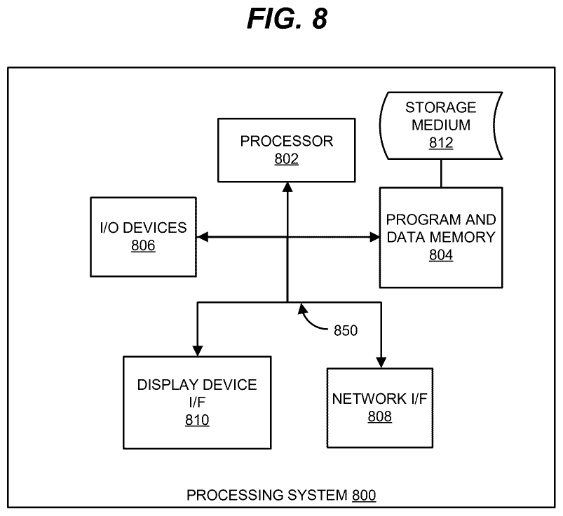

Embodiments disclosed herein can take the form of software, hardware, firmware, or various combinations thereof. In one particular embodiment, software is used to direct a processing system of a system or component described herein to perform the various operations disclosed herein. FIG. 8 illustrates a processing system 800 operable to execute a computer readable medium embodying programmed instructions to perform desired functions in an illustrative embodiment. Processing system 800 is operable to perform the above operations by executing programmed instructions tangibly embodied on computer readable storage medium 812. In this regard, embodiments can take the form of a computer program accessible via computer-readable medium 812 providing program code for use by a computer or any other instruction execution system. For the purposes of this description, computer readable storage medium 812 can be anything that can contain or store the program for use by the computer.

Computer readable storage medium 812 can be an electronic, magnetic, optical, electromagnetic, infrared, or semiconductor device. Examples of computer readable storage medium 812 include a solid state memory, a magnetic tape, a removable computer diskette, a random access memory (RAM), a read-only memory (ROM), a rigid magnetic disk, and an optical disk. Examples of optical disks include compact disk-read only memory (CD-ROM), compact disk-read/write (CD-R/W), and DVD.

Processing system 800, being suitable for storing and/or executing the program code, includes at least one processor 802 coupled to program and data memory 804 through a system bus 850. Program and data memory 804 can include local memory employed during actual execution of the program code, bulk storage, and cache memories that provide temporary storage of at least some program code and/or data in order to reduce the number of times the code and/or data are retrieved from bulk storage during execution.

Input/output or I/O devices 806 (including but not limited to keyboards, displays, pointing devices, etc.) can be coupled either directly or through intervening I/O controllers. Network adapter interfaces 808 may also be integrated with the system to enable processing system 800 to become coupled to other data processing systems or storage devices through intervening private or public networks. Modems, cable modems, IBM Channel attachments, SCSI, Fibre Channel, and Ethernet cards are just a few of the currently available types of network or host interface adapters. Display device interface 810 may be integrated with the system to interface to one or more display devices for presentation of data generated by processor 802.

Although specific embodiments were described herein, the scope of the invention is not limited to those specific embodiments. The scope of the invention is defined by the following claims and any equivalents thereof.

What is claimed is:

1. An apparatus, comprising:
a first frame member configured to couple with a first end of a damper;
a second frame member pivotably coupled with the first frame member, the second frame member configured to couple with a second end of the damper; and
a handle coupled to the second frame member, the handle configured to receive a manual force from a human operator to pivot the second frame member;
wherein the first frame member is configured to couple with a wall structure to suspend the first frame member off the ground and in a fixed position as the second frame member pivots to compress or extend the damper for performance testing.

2. The apparatus of claim 1, further comprising:
a displacement sensor configured to measure displacement of the damper as the second frame member pivots relative to the first frame member;
a force sensor configured to measure force produced by the damper as the second frame member pivots relative to the first frame member; and
a transceiver configured to receive displacement data from the displacement sensor and force data from the force sensor, and to transmit the displacement data and the force data to a computer device to display damping characteristics of the damper.

3. The apparatus of claim 2, wherein:
the force sensor comprises a load cell positioned between the damper and the second frame member.

4. The apparatus of claim 2, wherein:
the displacement sensor comprises an angular potentiometer aligned with a hinge axis of the second frame member.

5. The apparatus of claim 1, wherein:
the first frame member includes a first attachment structure configured to attach to the first end of the damper, the first attachment structure being adjustable along a length of the first frame member; and
the second frame member includes a second attachment structure configured to attach to the second end of the damper, the second attachment structure being adjustable along a length of the second frame member.

6. The apparatus of claim 5, wherein the first frame member is a first hollow tubular structure, comprising:
a back side including one or more fastener support holes to secure the back side to the wall structure via one or more fasteners;
side walls including opposing pairs of holes to support the first attachment structure; and
a front side including an opening to access a hollow interior of the first hollow tubular structure, wherein the opening aligns with the one or more fastener support holes of the back side to access the one or more fasteners to attach or detach the back side to or from the wall structure.

7. The apparatus of claim 6, wherein the second frame member is a second hollow tubular structure, comprising:
a back side including a series of holes spaced lengthwise to support the second attachment structure; and
a front side including an opening to access a hollow interior of the second hollow tubular structure.

8. The apparatus of claim 7, wherein:
the first frame member and the second frame member are configured to fold about a hinge axis to a closed position in which respective front sides face and contact each other.

9. The apparatus of claim 8, wherein:
in the closed position, the first attachment structure situates at least partially through the opening in the front side of the second frame member, and the second attachment structure situates at least partially through the opening in the front side of the first frame member.

10. The apparatus of claim 1, wherein:
the handle is adjustable to modify a leverage applied to the second frame member.

11. The apparatus of claim 10, wherein the handle comprises:
a tubular sleeve coupled to a back side of the second frame member;
a telescoping arm configured to slide and secure with respect to the tubular sleeve; and
a handlebar coupled to the telescoping arm.

12. The apparatus of claim 11, wherein:
the tubular sleeve is coupled to the back side of the second frame member via a block structure to provide a space offset between the handle and the second frame member.

13. The apparatus of claim 1, wherein:
the first frame member and the second frame member each comprise a hollow rectangular tubing.

14. The apparatus of claim 1, further comprising:
a hinge to pivotably join the second frame member and the first frame member;
wherein the hinge is positioned at a top end of the first frame member, and a hinge axis is positioned forward from the first frame member.

15. A method for testing a damper using a damper testing device, the method comprising:
securing a first frame member of the damper testing device to a wall to suspend the first frame member off the ground and in a fixed position;
mounting the damper between the first frame member and a second frame member that is pivotably attached to the first frame member; and
applying a manual force to the second frame member to compress or extend the damper as the second frame member pivots to test a performance of the damper.

16. The method of claim 15, further comprising:
receiving, from sensors coupled to the damper testing device, displacement data and force data measured during the test of the damper;
generating damper performance data based on the displacement data and the force data; and
displaying the damper performance data.

17. The method of claim 16, further comprising:
receiving input indicating a type of the damper to be installed with the damper testing device; and
generating, based on the type of damper, a first notification for a user indicating first instructions for attaching the damper to the damper testing device.

18. The method of claim 17 further comprising:
receiving confirmation that the damper is attached to the damper testing device according to the first instructions;
generating, in response to the confirmation, a second notification for the user indicating second instructions for calibration of one or more sensors of the damper testing device;
generating, in response to confirming the calibration of the one or more sensors, a third notification for the user indicating third instructions for hand-operating the damper testing device to test the damper; and
generating the damper performance data based on the type of damper and the displacement data and the force data.

19. A damper dyno system, comprising:
a damper dyno, comprising:
a first frame member configured to couple with a first end of a damper;
a second frame member pivotably coupled with the first frame member, the second frame member configured to couple with a second end of the damper;
a handle coupled to the second frame member, the handle configured to receive a manual force from a human operator to pivot the second frame member; and
sensors configured to measure displacement and force of the damper as the second frame member pivots relative to the first frame member;
wherein the first frame member is configured to couple with a wall structure to suspend the first frame member off the ground and in a fixed position as the second frame member pivots to compress or extend the damper for performance testing; and
a damper dyno computer system, comprising:
an interface configured to receive displacement data and force data from the sensors;
a processor configured to generate damping characteristics of the damper based on the displacement data and the force data; and
a display configured to display the damping characteristics of the damper.

20. The damper dyno system of claim 19, wherein the damper dyno computer system further comprises:
data storage configured to store dyno configuration data for different types of dampers;
wherein the processor is configured to generate instructions for operating the damper dyno based on the dyno configuration data.
